(19) United States
(12) Patent Application Publication
(10) Pub. No.: US 2010/0131362 A1
(43) Pub. Date: May 27, 2010

(54) ADVERTISING APPARATUS AND METHODS AND STORAGE MEDIUM

(76) Inventors: Chun-Ming LIANG, Kaohsiung City (TW); Jay SZETU, Taipei City (TW); Shih-Chun CHOU, Taipei City (TW); Wen-Tai HSIEH, Taipei City (TW)

Correspondence Address: BIRCH STEWART KOLASCH & BIRCH, PO BOX 747, FALLS CHURCH, VA, 22040-0747, US

(21) Appl. No.: 12/490,636

(22) Filed: Jun. 24, 2009

(30) Foreign Application Priority Data
Nov. 27, 2008 (TW) 97145900

(51) Int. Cl. G06Q 30/00; G06Q 99/00; G06F 17/00; G06F 15/16

(52) U.S. Cl. 705/14.49; 705/14.69; 715/205; 709/224; 705/319

(57) ABSTRACT

The invention discloses an advertising apparatus for generating a link corresponding to an advertisement, including a member module and an advertisement generation module. The member module generates a first public member ID for an advertiser account, wherein the advertiser account is logged onto a social networking platform on a first electronic device. The advertisement generation module generates the link including the first public member ID, and transmits the link to the first electronic device through the internet. The link is displayed on an editable space provided by the advertiser account.

This Application claims priority of Taiwan Patent Application No. 97145900, filed on Nov. 27, 2008, the entirety of which is incorporated by reference herein.

### BACKGROUND OF THE INVENTION

1. Field of the Invention

The invention relates generally to an advertising apparatus and method, and more particularly, to an advertising apparatus and method applied to social networking platforms.

2. Description of the Related Art

With increased internet access, advertising via the internet has grown in popularity. Additionally, internet social networks have also grown in popularity. Accordingly, advertising through users of internet social networks are growing in popularity. Conventionally, methods for adverting via the internet social networks include buying a space on a web page (such as side area on the web page) of a website, and providing advertisements thereon. However, flexibility for choosing and changing advertisements is often less than desired. Also, normally, the web areas for advertisements are placed on non-obvious areas of a web page, so the advertising visibility and benefit are decreased.

### BRIEF SUMMARY OF THE INVENTION

The invention discloses an advertising apparatus for generating a link corresponding to an advertisement, comprising a member module and an advertisement generation module. The member module generates a first public member ID for an advertiser account, wherein the advertiser account is logged onto a social networking platform on a first electronic device. The advertisement generation module generates the link comprising the first public member ID, and transmits the link to the first electronic device through the internet. The link is displayed on an editable space provided by the advertiser account.

The invention further discloses an advertising method for generating a link corresponding to an advertisement. The method comprises generating a first public member ID for an advertiser account, wherein the advertiser account is logged onto a social networking platform on a first electronic device. The method further comprises generating the link comprising the first public member ID, and transmitting the link to the first electronic device through the internet. The link is displayed on an editable space provided by the advertiser account.

The invention further discloses a storage medium for storing an advertising program, wherein the advertising program comprises a plurality of program codes to be loaded onto a computer system so that an advertising method generating a link corresponding to an advertisement is executed by the computer system. The method comprises generating a first public member ID for an advertiser account, wherein the advertiser account is logged onto a social networking platform on a first electronic device. The method further comprises generating the link comprising the first public member ID, and transmitting the link to the first electronic device through the internet. Wherein, the link is displayed on an editable space provided by the advertiser account.

### BRIEF DESCRIPTION OF THE DRAWINGS

The invention can be more fully understood by reading the subsequent detailed description and examples with references made to the accompanying drawings, wherein:

FIG. 1 shows a block diagram of an advertising system according to an embodiment of the invention;

FIG. 2 shows an operation flowchart of the advertising system according to an embodiment of the invention;

FIG. 3 shows a diagram of an advertiser posting a link on his/her MSN platform nickname area according to an embodiment of the invention;

FIG. 4 shows a diagram of the relationship among advertisers in a multi-level marketing structure according to an embodiment of the invention;

FIG. 5A shows a graphic interface provided for the advertisers to select the different types of advertisement required, according to an embodiment of the invention; and

FIG. 5B shows a matching mechanism between the advertisement client settings and the advertiser settings according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

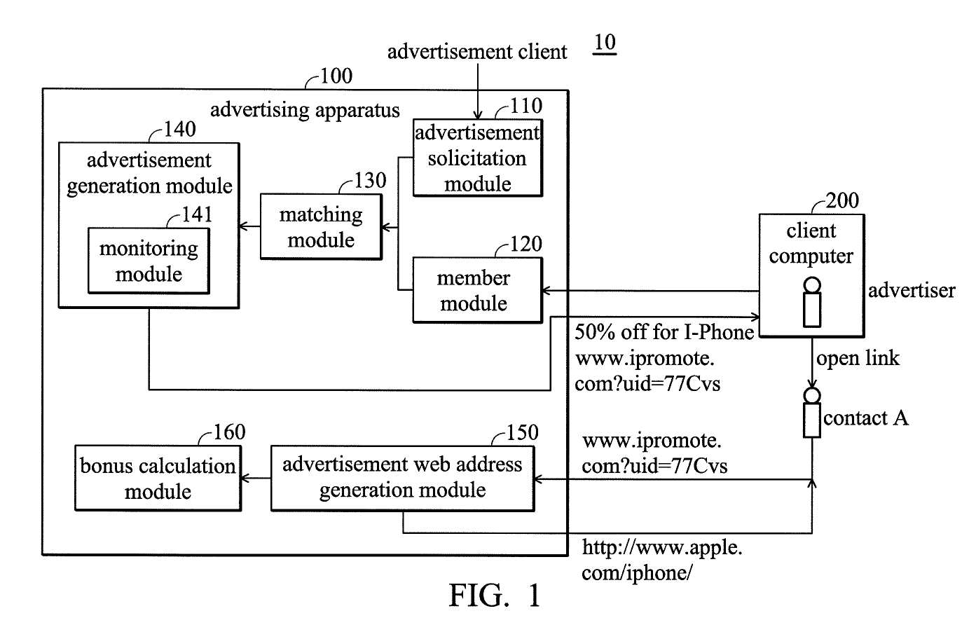

FIG. 1 shows a block diagram of an advertising system according to an embodiment of the invention. The advertising system 10 comprises an advertising apparatus 100 and a client computer 200. The advertising apparatus 100 comprises an advertisement solicitation module 110, a member module 120, a matching module 130, an advertisement generation module 140, an advertisement web address generation module 150 and a bonus calculation module 160. The advertisement generation module 140 further comprises a monitoring module 141. The client computer 200 is installed with a social networking platform, such as MSN Messenger, Yahoo! Messenger or Skype (non-limiting). An account is provided for a user to log onto the social networking platform, and the social networking platform provides a personal status or nickname area for the account of the user. In an embodiment of the invention, a user is able to use his/her account to log onto the social networking platform installed on the client computer 200 and to be an advertiser. Following, an operation flowchart of the advertising system 10 will be described in detail.

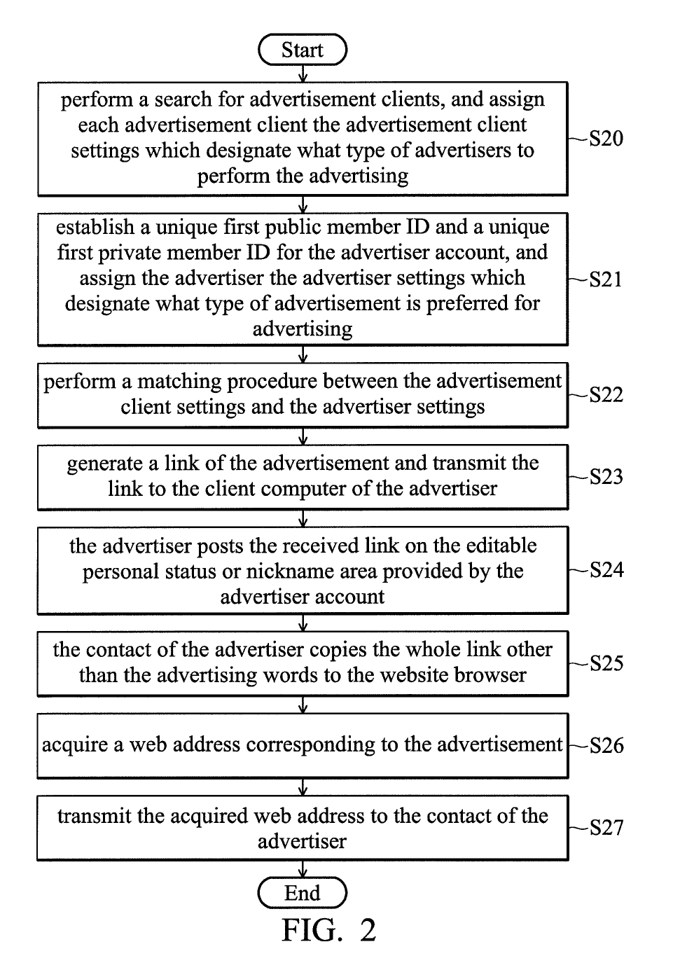

FIG. 2 shows an operation flowchart of the advertising system according to an embodiment of the invention. First, the advertisement solicitation module 110 of the advertising apparatus 100 solicits the advertisement clients (or advertisement suppliers) who have a lot of advertisements to be advertised (step S20). The advertisement client may be a sport franchise who has some sort of advertisements for promoting their game tickets, or a restaurant who has the advertisements to be advertised for promoting their new cuisine. Once potential advertisement clients have been identified, the advertising apparatus 100 processes registration of the potential advertisement clients. Registration information may include information such as the category of advertisements that require advertising (sport, food, etc), as well as the quantity, advertising words and the corresponding web addresses of the advertisements. After the registration of the advertisement clients, the advertisement solicitation module 110 recruits the potential advertisers who will participate or perform the advertising for the advertisement clients. In addition, each advertisement client may be assigned with an set of advertisement client settings designating what type of advertisers to perform the advertising for them (step S20). For participating the advertising, the advertisers are required to have a computer (such as the client computer 200) installed with the related social networking platform, as well as an account used to log onto the social networking platform for advertising purposes, also called “advertiser account”. When an advertiser desires participation in advertising, the advertising apparatus 100 is utilized to register submission of an advertiser account, wherein a unique first public member ID and a unique first private member ID is established for the advertiser account (step S21). Note that the MSN platform is used as a non-limiting example of a social networking platform in the preferred embodiment. Concurrently, the advertiser may also be assigned with the advertiser settings which designate what type of advertisement is preferred for advertising (step S21). Next, the matching module 130 performs a matching procedure between the advertisement client settings and the advertiser settings in order to select suitable advertisements for the advertiser (step S22). In addition, the amount of bonus or money to the advertisers is also calculated based on the matching result and effectiveness of the advertisements.

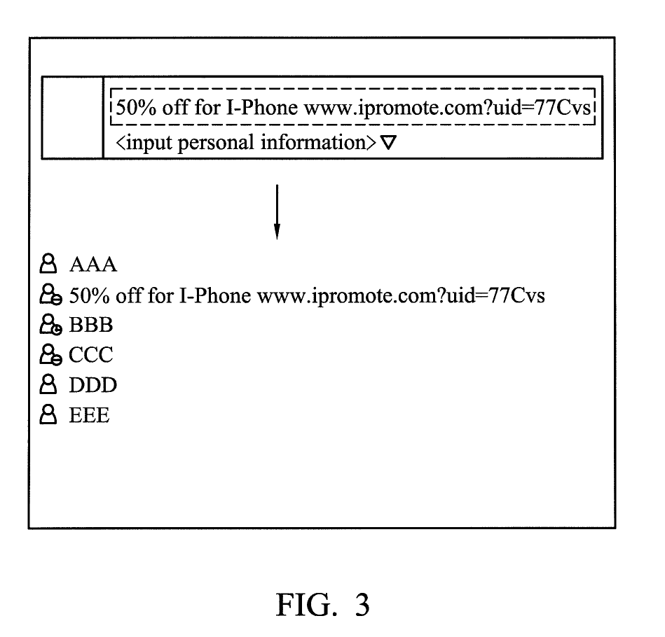

When an advertisement is selected to be advertised by an advertiser, the advertisement generation module 140 generates a link of the advertisement based on a first public member ID of the advertiser (or the advertiser account, specifically), and transmits the link to the client computer 200 through the internet for further advertising (step S23). Once the advertiser is logged onto the MSN platform with his/her advertiser account on the client computer 200, the advertiser posts the received link on the editable personal status or nickname area provided by the advertiser account (step S24), making the link public to all friends in the advertiser MSN contacts list. For example, if the advertisement is an I-Phone advertisement, and the first public member ID of the advertiser account is “77Cvs”, then the advertisement generation module 140 will generate a link such as “50% off for I-Phone www.ipromote.com?uid=77Cvs”. The link comprises the advertising words “50% off for I-Phone” which shows the discount information, as well as the first public member ID of the advertiser account “77Cvs”. Next, the advertisement generation module 140 transmits the link to the client computer 200 (advertiser) through the internet. Upon reception of the link “50% off for I-Phone www.ipromote.com?uid=77Cvs”, the advertiser can post the link on his/her MSN nickname area, as shown in FIG. 3.

Next, assume that the advertiser account has contact A in his/her MSN contacts list, and contact A is also logged onto the MSN platform on another computer. When the advertiser posts the received link on his/her MSN nickname area, contact A will notice that the advertiser account nickname area has been replaced with the link. Then contact A, if interested, may copy the whole link other than the advertising words (www.ipromote.com?uid=77Cvs) to his/her website browser (step S25) in order to open the link (note that for some social networking platforms such as Skype, the link can be directly opened by simply clicking on the link without copying it to the website browser). Once the link is opened, a link-clicking signal is issued from contact A computer to the advertisement web address generation module 150 and recorded in the advertisement web address generation module 150. Then, the advertisement web address generation module 150 identifies the advertiser posting the advertisement, in order to calculate the bonus for that advertiser. Identifying the first public member ID from the link, which is “77Cvs” in this embodiment, may be one method of establishing the advertiser. Based on the identified advertiser, the bonus calculation module 160 calculates the bonus for the advertiser (for the advertiser account). In addition, the advertisement web address generation module 150, according to the identified first public member ID “77Cvs”, is also able to identify what type of advertisements are going to be advertised by the advertiser (because each advertiser was assigned with a set of unique defined advertiser settings designating what type of advertisement is preferred for advertising), which is I-Phone in this embodiment. In response, the advertisement web address generation module 150 acquires a web address corresponding to the I-Phone advertisement (step S26), and transmits the acquired web address to contact A computer for his/her advertisement viewing (step S27). With the proposed method described above, marketing of advertisements can be effectively enhanced through the increasingly-popular social networking platforms.

In step S21, as an example, an advertiser solicits new advertisers through their MSN contacts list. At which time, the advertising apparatus 100 provides the first private member ID of the advertiser to the potential new advertisers which are solicited by the advertiser. Accordingly, the potential new advertisers may use the first private member ID to register for an advertiser status. Should the potential new advertisers register for advertisers status, the member module 120 would next generate a unique second public member ID and a unique second private member ID for the registered new advertisers. The described process may be unlimitedly repeated amongst the registered new advertisers and their registered new advertisers and so on.

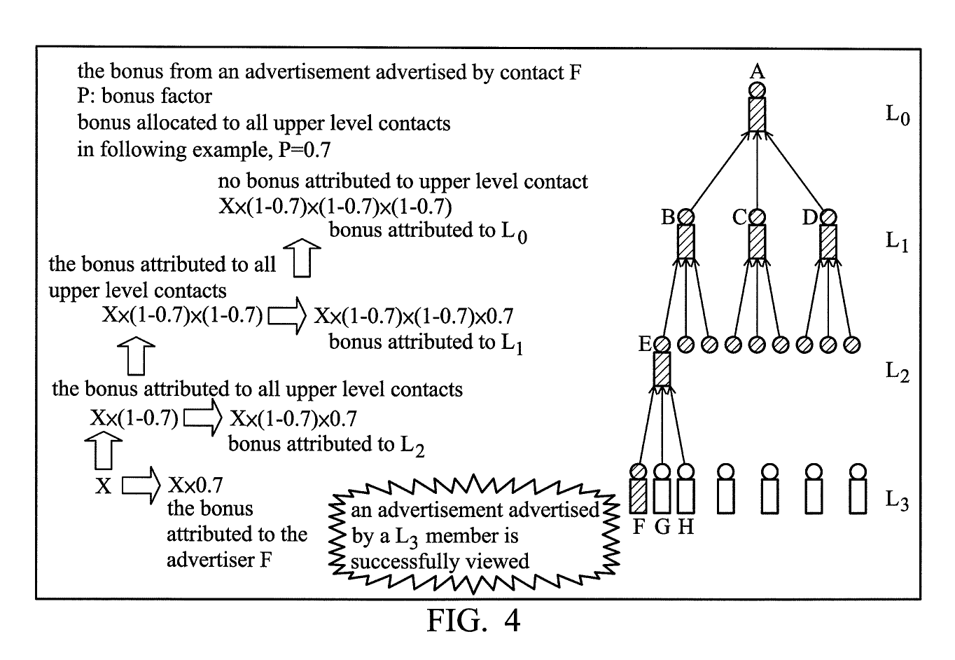

FIG. 4 shows a diagram of the relationship among advertisers in a multi-level marketing structure according to an embodiment of the invention. Referring to FIG. 4, assume that the advertiser A on the root (level 0, L0) has contacts B, C and D (level 1, L1), contact B has contacts E (level 2, L2), and contact E has contacts F, G and H (level 3, L3). Thus, when an advertisement advertised by contact F is successfully viewed, a bonus is not only allocated to contact F but to all upper level contacts. Specifically, assume that the bonus from an advertisement advertised by contact F is X and a 70% bonus factor is used. Thus accordingly, contact F would be attributed a bonus of 0.7X, contact E would be attributed a bonus of (1−0.7)*0.7X, contact B would be attributed a bonus of (1−0.7)*(1−0.7)*0.7X, and the root contact A would be attributed a bonus of (1−0.7)*(1−0.7)*(1−0.7)*0.7X.

In step S22, a matching procedure is performed between the advertisement client settings and the advertiser settings. Detailed description of the matching procedure is as follows.

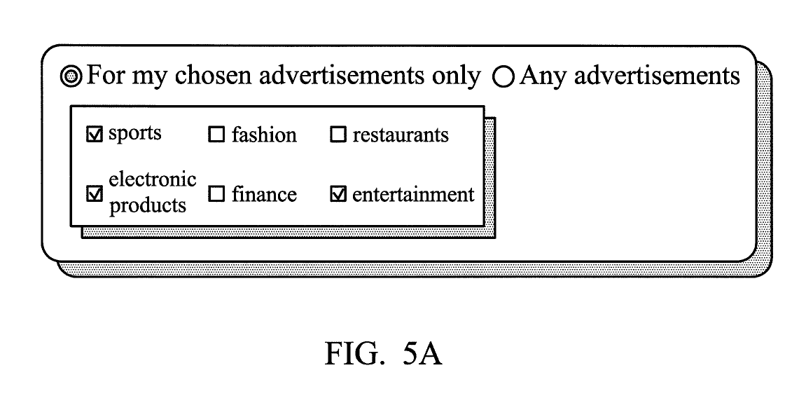

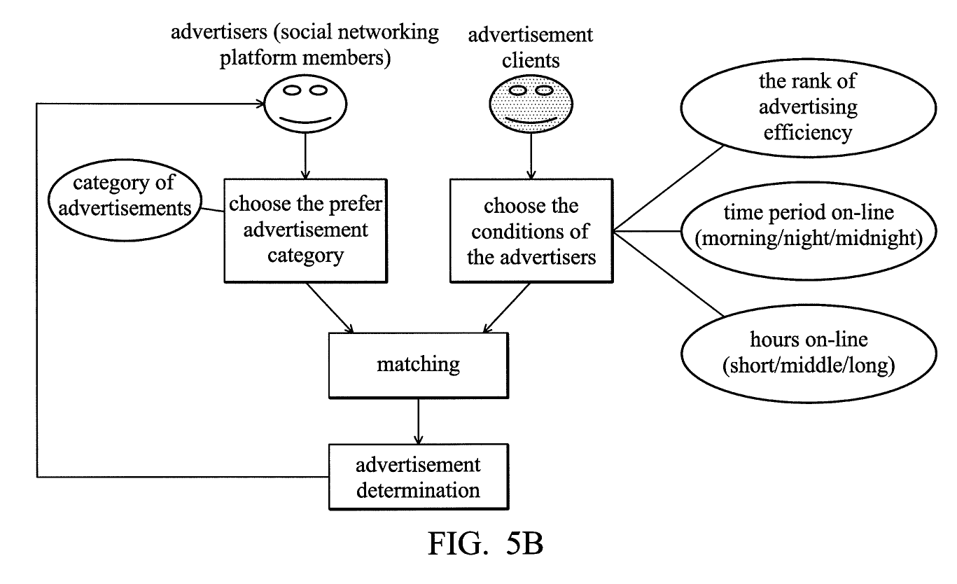

Referring to FIG. 5A, a graphic interface is provided for the advertisers to select the different types of advertisement required. As shown in FIG. 5A, the graphic interface allows the advertiser to select categories such as sports, fashion, restaurants, electronic products, finance and entertainment and the like. Besides, the advertisement clients, by using the advertisement client settings, is also able to select what type of advertisers to perform the advertising for them. The conditions for selection of advertisers are based on the follows:

(1) The efficiency (defined as valid clicks over a period of advertising time) attributed to the advertiser. The definition of valid clicks may depend on two factors: the number of clicks that is acknowledged as valid, and the amount of time an advertisement is opened. For the first factor, as an example, if an advertisement is repeatedly clicked by the same viewer within 24 hours, then only one click is regarded as valid. For the second factor, if an advertisement is open for a short time, said one second, then the click is also not regarded as valid. Thus, the higher the efficiency, the larger the required bonus.

(2) Amount of time on-line of the advertiser. To estimate the amount of time on-line, a monitoring account is provided by the monitoring module 141 of the advertising apparatus 100. The advertiser is required to add this monitoring account in their contact list so that their on-line status can be monitored and recorded. On-line time may be determined in hours, days, and weeks or longer. Thus, the greater the amount of time online, the larger the required bonus.

(3) Amount of contacts of the advertiser having submitted an appropriate account name and password detectible by the advertising apparatus 100. Thus, the higher the number of contacts, the larger the required bonus.

Referring to FIG. 5B, the matching module 130 performs a matching procedure between the advertisement client settings and the advertiser settings. An advertisement to be advertised is determined according to a match between the advertiser settings and the advertiser settings. Additionally, apart from the matching procedure for determining at least an advertisement to be advertised by an advertiser, prioritization of advertisements may be performed by the matching module 130; especially for free advertisers. One example of a prioritization condition is the highest number of required clicks. Thus, for this example, among the plurality of advertisements, the advertisement with the highest number of required clicks would first be chosen to be advertised by the free advertisers. Additionally, the prioritization condition may also be applied to the bonus calculation formula. Herein, using the highest number of required clicks as the prioritization condition, if the advertisement has the highest number of required clicks then the bonus to the advertiser would also be higher, thus optimizing the advertising method.

Note that the MSN platform is used as a non-limiting example of a social networking platform in the above description. For other different social networking platforms such as Twitter, an advertiser account is still required for an advertiser to log onto the social networking platform and post a received link corresponding to an advertisement on the editable personal status or nickname area provided by the advertiser account. However, for social networking platforms such as Twitter, which do not require installation of application specific software, access to advertisements are not limited.

In another embodiment, the advertiser account may only have a first public member ID and not a first private member ID. In this case, the first public member ID is used for both the advertisement generation module 140 to generate a link corresponding to an advertisement and the member module 120 to solicit new advertisers. Thus, the member module 120 would only generate a second public member ID for a new advertiser and not a second private member ID, and the new advertiser would be able to use the second public member ID to perform advertising.

The advertising method of the invention can be recorded as a program in a storage medium for performing the above procedures, such as an optical disk, floppy disk and portable hard drive and so on. It is to be emphasized that the program of the advertising method is formed by a plurality of program codes corresponding to the procedures described above.

While the invention has been described by way of example and in terms of the preferred embodiments, it is to be understood that the invention is not limited to the disclosed embodiments. To contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An advertising apparatus for generating a link corresponding to an advertisement, comprising:
a member module generating a first public member ID for an advertiser account, wherein the advertiser account is logged onto a social networking platform on a first electronic device; and
an advertisement generation module generating the link comprising the first public member ID, and transmitting the link to the first electronic device through the internet, wherein the link is displayed on an editable space provided by the advertiser account.

2. The advertising apparatus as claimed in claim 1, wherein a contact of the advertiser account is registered on the social networking platform, and the contact logs onto the social networking platform on a second electronic device.

3. The advertising apparatus as claimed in claim 2, wherein the member module further generates a first private member ID for the advertiser account, and generates a second public member ID and a second private member ID for the contact according to the generated first private member ID.

4. The advertising apparatus as claimed in claim 2, further comprising an advertisement web address generation module acquiring a web address corresponding to the advertisement according to the generated link, and transmitting the acquired web address to the second electronic device through the internet, when receiving a link-clicking signal from the second electronic device.

5. The advertising apparatus as claimed in claim 4, further comprising a bonus calculation module identifying the advertiser account from the generated link, and calculating the bonus for the identified advertiser account, when receiving the link-clicking signal from the second electronic device.

6. The advertising apparatus as claimed in claim 1, wherein the advertisement generation module further comprises a monitoring module monitoring the online status of the advertiser account.

7. The advertising apparatus as claimed in claim 1, further comprising a matching module selecting the advertisement from a plurality of advertisements for advertising, according to a condition match between an advertiser setting and an advertiser setting.

8. An advertising method for generating a link corresponding to an advertisement, comprising:
generating a first public member ID for an advertiser account, wherein the advertiser account is logged onto a social networking platform on a first electronic device;
generating the link comprising the first public member ID; and
transmitting the link to the first electronic device through the internet, wherein the link is displayed on an editable space provided by the advertiser account.

9. The advertising method as claimed in claim 8, wherein a contact of the advertiser account is registered on the social networking platform, and the contact logs onto the social networking platform on a second electronic device.

10. The advertising method as claimed in claim 9, further comprising:
generating a first private member ID for the advertiser account; and
generating a second public member ID and a second private member ID for the contact according to the generated first private member ID.

11. The advertising method as claimed in claim 9, when receiving a link-clicking signal from the second electronic device, further comprising:
acquiring a web address corresponding to the advertisement according to the generated link; and
transmitting the acquired web address to the second electronic device through the internet.

12. The advertising method as claimed in claim 11, when receiving the link-clicking signal from the second electronic device, further comprising:
identifying the advertiser account from the generated link; and
calculating the bonus for the identified advertiser account.

13. The advertising method as claimed in claim 8, further comprising monitoring the online status of the advertiser account.

14. The advertising method as claimed in claim 8, further comprising selecting the advertisement from a plurality of advertisements for advertising, according to a condition match between an advertiser setting and an advertiser setting.

15. A storage medium for storing an advertising program, wherein the advertising program comprises a plurality of program codes to be loaded onto a computer system so that an advertising method generating a link corresponding to an advertisement is executed by the computer system, and the advertising method comprises:
generating a first public member ID for an advertiser account, wherein the advertiser account is logged onto a social networking platform on a first electronic device;
generating the link comprising the first public member ID; and
transmitting the link to the first electronic device through the internet, wherein the link is displayed on an editable space provided by the advertiser account.

16. The storage medium as claimed in claim 15, wherein a contact of the advertiser account is registered on the social networking platform, and the contact logs onto the social networking platform on a second electronic device.

17. The storage medium as claimed in claim 16, wherein the advertising method further comprises:
generating a first private member ID for the advertiser account; and
generating a second public member ID and a second private member ID for the contact according to the generated first private member ID.

18. The storage medium as claimed in claim 16, wherein the advertising method, when receiving a link-clicking signal from the second electronic device, further comprises:
acquiring a web address corresponding to the advertisement according to the generated link; and
transmitting the acquired web address to the second electronic device through the internet.

19. The storage medium as claimed in claim 18, wherein the advertising method, when receiving the link-clicking signal from the second electronic device, further comprises:
identifying the advertiser account from the generated link; and
calculating the bonus for the identified advertiser account.

20. The storage medium as claimed in claim 15, wherein the advertising method further comprises monitoring the online status of the advertiser account.
